(19) United States
(12) Patent Application Publication
(10) Pub. No.: US 2005/0144063 A1
(43) Pub. Date: Jun. 30, 2005

(54) Method and system for the determination and dissemination of brand-related artwork on commodity-based products

(76) Inventor: Donald Spector, New York, NY (US)

Correspondence Address: Mitchell A. Stein, Esq.;STEIN LAW, P.C., Suite 4, 24 Woodbine Avenue, Northport, NY, 11768, US

(21) Appl. No.: 10/741,076

(22) Filed: Dec. 19, 2003

(51) Int. Cl. G06F 17/60

(52) U.S. Cl. 705/14

(57) ABSTRACT

A method and system for utilizing impressions, including advertising logo's and other licensable advertisements, for placement upon commodity-based products (like disposable cups, packaging, plates, utensils and the like), such that licensing revenue or other advertising revenue offset the cost of manufacture of such commodity-based products as well as the cost of purchase of such commodity-based products (to the point of potentially zero) by those non-franchised entities like delicatessens, diners, restaurants, and the like, and even potentially the ultimate purchaser of the food or beverage therein contained, by which a library of licensable impressions are maintained and a system and method is employed to control the library, commodity-based manufacturers and commodity-based purchasers, including demographic data, geographical data, customer lists, and/or data related to a targeted audience of potential purchasers of materials to whom advertisements are thereby directed.

### FIELD OF THE INVENTION

The present invention relates to the field of branding commodity products, and more particularly to a method and system for applying logo's and other images to commodity products as a mechanism for advertisement, the generation of revenue, and reduction of the cost to the ultimate purchaser of the commodity-based products from the distributor or manufacturer.

### BACKGROUND OF THE INVENTION

One may purchase a soda at a franchised burger dealer, and therein receive a cup with a famous trademark thereupon (generally in conformity with the product purchased). Yet, the person who frequents delicatessens, diners, take-out facilities, and straight beverage-related vendors (like non-franchised coffee vendors or street carts) who purchases a beverage, generally receive the beverage dispensed from a machine typically into a cup with a fairly nondescript image (like a colorful splash) imprinted or otherwise impressed upon the cup. Likewise, one who purchases a meal from a non-franchised chain (that does not use, for example, non-paper based products collected at the conclusion of the meal) including, e.g., take-out locations like restaurants (including, with no ethnicity specifically intended, e.g., Greek or Chinese food locations), receives a plate or other food in a container that is either blank or contains a fairly nondescript impression at times having some color. More often then not, these commodities-based products (which generally include any paper or other material suitable for the containment of food or beverage-based products for the purposes of this invention), are blank, containing nothing whatsoever, and to the extent an image is provided, it is nondescript, generally of no significance, generally forgettable and forgotten, and generally unrecognizable as a since source or origin of food or beverages.

It is surprising to note that the commodities-based manufacturing and purchasing industry is not trivial in its size and gross sales. Rather this industry is huge in financial magnitude, to the point that nearly tens of billions of commodities per year are manufactured, purchase, sold and dispensed, from plates, cups, utensils, other containers (like the odd Chinese food holder) and all sorts of food and beverage containers and materials. These gross dollar figures exclude the pre-branded commodities that are required by the wealth of franchisees to be employed by way of other pre-existing contractual requirements associated with such distribution systems. In such excluded sales, commodity-based products already contain recognizable imprints as a part of a pre-existing contractual or other license arrangement (e.g., a large franchisee will typically require that its brand be utilized on all food and beverage containment commodities-based products).

Thus, sales of commodities-based products that are unbranded generally constitute an unregulated, untapped commercial community that comprises first the commodities manufacturers, who sell at a very tight margin and seek to make profit in volume, and generally sell such commodities with either pleasant, nondescript yet non-offensive patterns, with generally the same series of nondescript patterns. Secondly purchasers of such commodities-based products, who comprise generally diners, restaurants, take-out facilities and the like, purchase such generic commodity-based products from those who provide the best prices. This system of unbranded manufacture and sale of commodities-based products, is generally controlled by tight costs and margins, but exists in this format essentially worldwide.

From the perspective of the commodities buyer, e.g., a diner, the issue does not typically involve any great loyalty to the commodities-based supplier. The question is simple: who can sell standard quality commodities-based products in the volume needed at the time required, with regularity, at the least expensive price? The answers to this series of questions generally dictates the purchase.

Viewing the issue, then, from the standpoint of the commodities-based manufacturer, anything that increases competitive advantage by reducing the cost of the commodities-based products to the purchaser increases the competitive advantage of the manufacturer and the volume of acquisition by the purchaser. Viewing the issue from the commodity purchaser's vantage point, anything that reduces cost and increases the likelihood of and volume of purchase of the food or beverage therein contained increases its competitive advantage as well as the bottom-line profit to the commodity purchaser who sells and distributes food material through such commodity-based products.

Moreover, these commodities have visibility to the general public upon use and distribution, beyond mere utility to dispense foods and beverages. Not only does the purchaser of the food or beverage “see” the commodity-based product that contains the food or beverage (and, with a blank or nondescript impression pays limited attention), but the commodity-based product is also visible (when the food or beverage is consumed or carried) to others in any public place. For example, the person who walks down the street carrying a cup of coffee purchased from a vendor (not a franchised or other licensed provider), has a cup that is visible to others. Thus, an advertising advantage is available through a relatively inexpensive vehicle by which virtually millions of viewers can view the commercial product as an advertisement, at a cost significantly lower than more traditional routes that include, by way of example, targeting media advertising (mailing, television, radio, etc.).

Heretofore there has been no structure for taking advantage of this commercial opportunity by utilizing commodities-based products as an advertising vehicle, thereby permitting an entity to use the commodity-based product as a vehicle to advertise a brand and pay for such advertisement via, for example, the brand's advertising budget. Inherently, such a method and system also reduces the cost to the manufacturer and purchaser of the commodity-based product (and even potentially the consumer) and creates direct profit potential (licensing, for example, of a logo) as well as downstream cost reduction.

It is thus an object of the instant invention to provide a method and system by which advertisers and other licensable brands, logo's, images and impressions (generally called “impressions” for the purposes of this invention) can license or otherwise commercially exploit these impressions (generally referred to as “licensing” for purposes of this invention), and receive royalties or advertising as a benefit, while either reducing or unchanging the costs of manufacture, sale and distribution, thereby reaching an audience in the millions whose simple use of the commodity-based product for the consumable therein contained, has become an advertising vehicle.

It is an additional object of the instant invention to reduce the traditional cost, i.e., the cost that a purchaser of commodities would ordinarily pay in the absence of the invention, for the purchase of commodity-based products.

It is yet a further object of the instant invention to provide a revenue stream for licensing impressions as an advertising method and system by placing impressions upon heretofore unbranded commodity-based products and charging a licensing fee for such activity including, without limitation, an advertising fee directly from the owner of the impression.

It is yet a still further object of the instant invention to reduce the cost, potentially to zero, to a purchaser of commodities upon which licensed impressions are placed, where the costs (to the licensor, manufacturer, distributor, and/or purchaser of such commodity-based products) as well as the purchaser is offset by the placement of the impression thereupon.

It should be observed that other objects of the invention can be comprehended by those of normal skill in the art, in that, for example, the method and system can be geographic or time-based in distribution (like announcements of upcoming events, movie or television releases and the like to specific locations), all as part of the term “impressions,” through pre-existing and established commodities-based distribution systems thereby permitting controlled usage of these impressions and virtually automatic, periodic, and controlled advertising, at reduced costs to all in the stream of advertising, manufacturer, distribution and consumption. Such commodity-based products are consumable and generated and used in great volume. In use, such commodity-based products, when imprinted, are generally visible to the purchaser of the food material therein contained as well as all others who observe the consumption, thereby creating a vehicle for advertising heretofore unrealized while increasing the competitive advantage to the commodity-based manufacturers and purchasers as a result of the cost reduction (costs being offset by way of advertisements) and a generally inexpensive advertising fee (in comparison to more traditional routes) while reaching a sizeable audience.

The wealth of other objects can well be comprehended from a complete reading and comprehension of the method and system herein disclosed and claimed.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method and system for utilizing impressions, including advertising logo's and other licensable advertisements, for placement upon commodities (like disposable cups, packaging, plates, utensils and the like), such that licensing revenue or other advertising revenue are used to offset (to the point of potentially zero) the cost of manufacture of commodities as well as the cost of purchase of such commodities by those non-franchised entities like delicatessens, diners, restaurants, and the like. A library of licensable impressions are maintained and a system and method is employed to control the library. Commodities manufacturers and commodities purchasers including demographic data, geographical data, customer lists, and/or data related to a targeted audience of potential purchasers of materials are maintained to thereby reach and direct advertisements.

In particular, by way of the instant invention, at least one impression is made available to at least one commodity-based product manufacturer. The impression is collected from a library of either known, licensable trademarks and copyrights, or from advertiser lists. The impression-based commodity is then offered to purchasers (like delicatessens, diners and the like) that purchase bulk quantities of such disposable commodities, but generally purchase them without licensed impressions. Since such purchasers are seeking the least expensive solution to acquire such commodity-based products, the method and system of the current invention can reduce their costs or purchase, potentially to almost nothing, thereby increasing the competitive advantage.

For example, if an advertiser seeks to advertise (even (by way of a non-limiting example) a specific movie for a specific geographical area), the method and system will virtually render the consumable commodity almost free, since the advertiser will pay part or all of the costs just to get the commodity into the market place. In other instances, a license fee is collected.

The transaction is facilitated by the method and system, which maintains the advertiser lists, licensed library, interfaces with the commodities providers to reduce the costs to the purchaser, and controls distribution and usage. If, for example, the audience is targeted, the advertiser will pay for the targeting, the provider will be supervised (for quality control and costs) and ultimately the purchaser of the commodities will find the price lower, with no impact on distribution. Indeed, if a commodities-based purchaser is given an “exclusive” license for a “hot” upcoming event, that purchaser, having the licensed impression, may actually find business increasing to the extent that the commodities are short-lived in production, and may become collectors items. Indeed, some may buy the beverage or food material for the value of the container. Generally speaking, the hotter the advertisement, the shorter the lifespan of the advertising through the commodity, and the more exclusive the distribution, the greater the chances of increased sales by the purchaser of the branded commodity-based product to the ultimate consumer. This, decrease in cost and increase in volume (depending upon the item) will likely drive further business to the “exclusive” provider of the commodity.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a general, overall systems diagram of the preferred embodiment of the subject invention; and

FIG. 2 is a more detailed systems diagram of the method and system of the preferred embodiment of the subject invention with greater emphasis on the role of systems agent 2, as shown in FIG. 1.

### DETAILED DESCRIPTION OF THE PREFERRED EMBODIMENTS

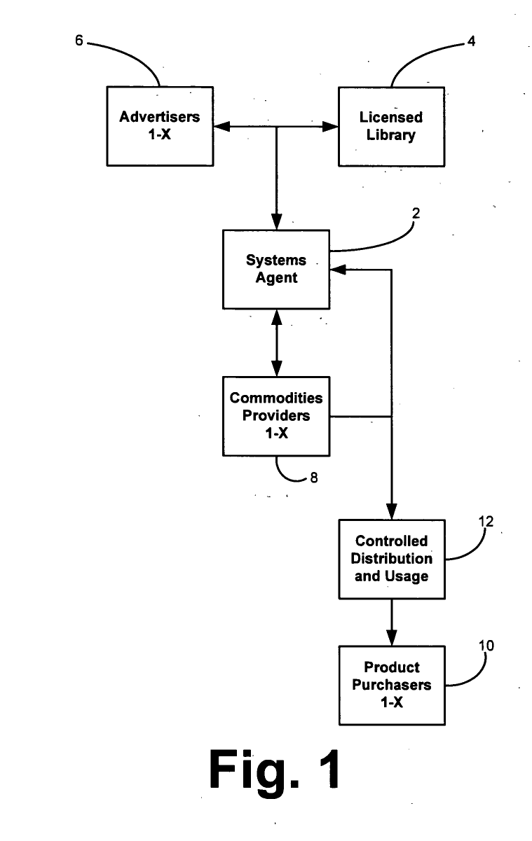

In accordance with the subject invention, FIG. 1, systems agent 2 is shown, which is the controller of the entire system and method of the preferred embodiment of the subject invention. As shown in FIG. 1, advertisers 1-X (being an unknown quantity potentially enormous in number, but also potentially changing depending upon the advertisement and its life-expectancy) as shown in item 6, interface directly with systems agent 2. Likewise, systems agent 2 maintains a library of licensable impressions which may include artwork, logo's, copyrighted material and even public domain material.

By way of example, and not for limiting purposes, advertisers 1-X in item 6 can be known logo's, and licensed libraries 4 can include, e.g., items like Monopoly logo's. Fees may be generated for licensing, which may increase manufacturing and purchasing costs, while, on the other hand, item 6 advertisements may offset the entire costs by paying for both manufacture and eventual product purchasing, since distribution may be large enough to justify full payment by the advertisers.

As shown further in FIG. 1, systems agent 2 also controls commodities providers 1-X, as shown in item 8. The commodities business is a low per-item profit business, where the majority of the revenue (absent the instant invention) is typically created by the quantities purchased. It can be well understood that the method and system embodied herein creates an entirely different paradigm, and hence control over the providers, as shown in item 8, becomes an important element not only because the licensing under items 6 and 8 require quality control (as a normal aspect of licensing) but because of the competitive nature of the industry. A “hot” licensable logo will permit systems agent 2 to negotiate better deals among commodities provider 1-X as shown in item 8.

Further as shown in FIG. 1, systems agent 2 controls distribution and usage of the commodity-impressed item by box 12, in that designated geographical or time-dependent advertising are an aspect of an advertiser's desire where, e.g., the advertisement is of a new movie (for which the commodities may be sought to be consumed prior to its release) or of an upcoming event (where the commodities must be consumed prior to the event). Thus, product purchaser 1-X shown in box 10 are controlled by the system, as shown in FIG. 1, since in some instances the control is negligible (where, for instance, timing and geographical distribution is irrelevant) and in other instances critical, as stated above.

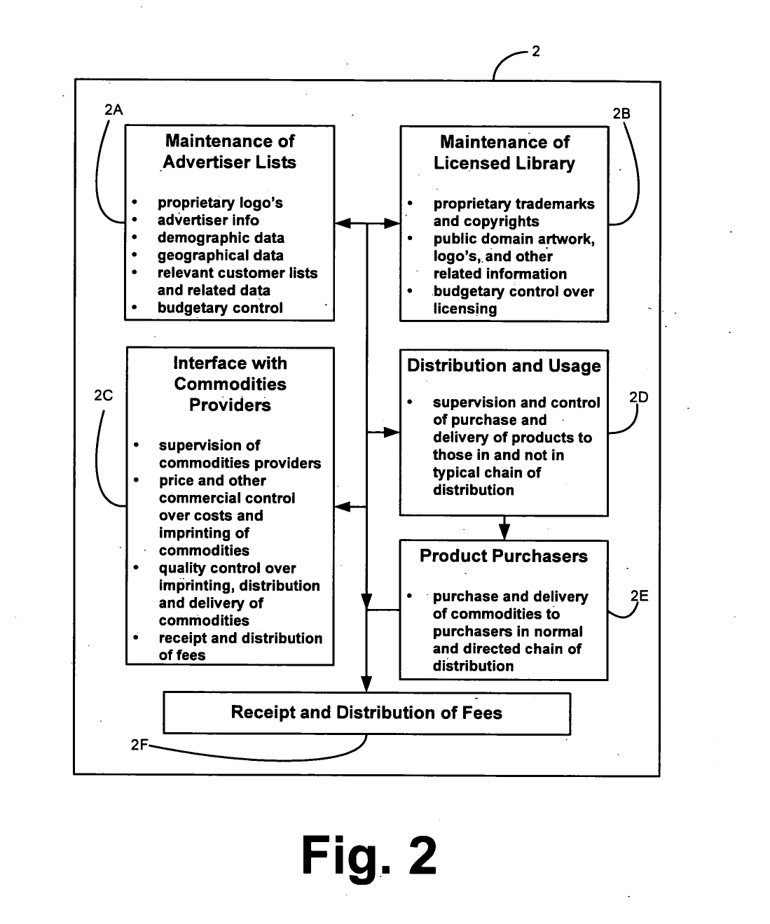

FIG. 2 shows a more detailed description of certain aspects of systems agent 2. In particular, systems agent 2 maintains the advertiser lists, as shown in time 2A, which include, without limitation, advertiser(s)' proprietary logos, data (“info”), demographic and geographical data (one would not expect cups for a local event to be sold in a distant location), relevant customer lists and related data, and control over the budget (evidently the costs of the method and system must generate profit, without increasing the costs of the product to commodities' purchasers without such purchaser achieving some economic benefit, including, e.g., reduction in the cost to them of the branded product and/or increase in sales volume).

In FIG. 2, systems agent 2 also controls and the maintains the licensed library via element 2B. Many logo's and other artwork are available for licensed use, but simply have never been applied in this manner. For instance, and only by way of hypothetical example, should a major franchise elect to have a series of photographs by a renowned photographer on a series of coffee cups, then system agent 2, through licensed library element 2B, would come into play to control the usage and distribution (as shown by element 12 in FIG. 1). Thus, maintenance of licensed library 2B includes, without limitation, proprietary trademarks and copyrights, public domain artwork (for which no royalty is necessary but commodities' purchasers might still see a competitive advantage and pay an extra fee for such usage), other related information, and, of course, maintenance of budgetary control to ensure that all interested parties are properly paid and the transactions consummated with payment in accordance with agreed terms.

FIG. 2 also include item 2C: the interface with commodities providers. Since the margin is tight and competition significant, systems agent 2, among other things, and without limitation, supervises the commodity providers, handles prices and other commercial control overs costs and imprinting of commodities, exercises quality control over imprinting, distribution and delivery of commodities (as is typically required in any trademark license), and receives and distributes fees in accordance with agreed contractual terms.

Also as shown in FIG. 2, distribution and usage is indicated in item 2D. In particular, but without limitation, systems agent 2 supervises and controls purchase and delivery of products to those both in, and not in the typical chain of distribution. By way of further explanation, commodities are already purchased and sold (generally with non-descript non-branded imprints) as a heretofore typical chain of distribution. Such purchasers will evidently benefit by use of the method and system of the current invention. It is contemplated that the presence of advertising in this medium in accordance with the preferred embodiment of the subject invention, will also create so-called “atypical” chains of distribution (e.g., commodity coffee cups by a drug store that has never sold such consumables before in anticipation of an upcoming local event) which, as well, are controlled by systems agent 2 via element 2D.

Lastly, product purchasers are considered in element 2E of FIG. 2, which involves, without limitation, purchase and delivery of commodities to purchasers in the normal and directed chain of distribution. By now it should be clear to one of ordinary skill in the art, armed by the teachings of the subject invention, that the claimed method and system disclosed and claimed herein permits a directed chain of distribution. For example, a well-known celebrity, like a folk singer or a person running for election, may license a visage and system 2 will control and direct the chain of distribution through element 2E. Normal distribution is, as well, contemplated, and consistent with that known by one of ordinary skill in the art, who has read and comprehended the subject invention, as disclosed and claimed.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method for providing at least one impression on at least one commodity-based product, comprising:
(a) making commercially available at least one impression on at least one commodity-based product;
(b) offering at least one of said at least one product containing the at least one impression to at least one commodity purchaser;
(c) facilitating the commercial transaction by which the commodity purchaser receives the at least one product;
(d) receiving a commercial advantage as a result of said facilitated transaction.

2. The method of claim 1, wherein said impression is selected from a group of licensable trademarks.

3. The method of claim 1, wherein said impression is selected from one or more advertisers.

4. The method of claim 1, wherein said commodity-based product is comprised of paper.

5. The method of claim 1, wherein said commodity-based products selected from the list comprising cups, plates, utensils, and related food-containment and presentation products.

6. The method of claim 1, wherein said offering at step (b) is at a cost that is below the cost of a commodity-based product that lacks said at least one impression.

7. The method of claim 1, wherein said step (c) comprises:
(a) maintaining a library of said impressions;
(b) offering said at least one commodity-based purchaser at least one of said licensable impressions for placement upon said at least one commodity-based product;
(c) obtaining a selection by said at least one commodity-based purchaser of at least one of said licensable impression from said library to be placed upon said at least one commodity-based product;
(d) interfacing with at least one provider to provide said selected at least one impression upon said at least one selected product and to distribute said at least one product with said at least one impression placed thereupon;
(e) consummating a transaction by which said purchaser acquires one or more of said at least one selected product with said at least one impression placed thereupon;
(f) collecting a fee for performing the method.

8. The method of claim 8, wherein said library is licensable and selected from the group comprising advertiser-based impressions and other licensable impressions.

9. The method of claim 8, wherein said offering step (b) is based upon data selected from the group comprising demographic data, geographical data, customer lists, and/or data related to a targeted audience of potential purchasers of materials to be placed in said at least one-commodity based product.

10. The method of claim 7, wherein said collection of a fee step (f) comprises a royalty.

11. The method of claim 7, wherein said collection of a fee step (f) comprises a reduction of the cost to said purchaser in connection with the consummation step (e).

12. A system for providing an impression upon a commodity, comprising the steps of:
(a) maintaining a library of licensable impressions;
(b) maintaining a list of commodity suppliers capable of placing at least one licensable impression upon a multiplicity of commodities;
(c) selling purchasers commodities with impressions from said library at a cost less than traditional costs for said commodities from at least one of said commodity suppliers;
(d) charging a fee for use of the system.

13. The system of claim 12, wherein said fee is a royalty paid by the advertiser.

14. The system of claim 12, wherein at least a portion of said fee is utilized to reduce the cost of sale to the purchaser.

15. The system of claim 12, wherein at least a portion of said fee is utilized to reduce the cost of manufacture by the commodity suppliers.
